(19) United States
(12) Patent Application Publication
(10) Pub. No.: US 2006/0260765 A1
(43) Pub. Date: Nov. 23, 2006

(54) Venetian-type blind

(75) Inventors: Emilio Antonini, Trieste (IT); Giulio Perissutti, Trieste (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Compagnia Servizi Industriali - C.S.I. - SrI

(21) Appl. No.: 11/265,950

(22) Filed: Nov. 3, 2005

(30) Foreign Application Priority Data
May 20, 2005 (IT) UD2005A000082

(51) Int. Cl. E06B 9/30

(52) U.S. Cl. 160/168.1 R

(57) ABSTRACT

Venetian-type blind (10), disposed to cover an aperture of a wall and comprising a plurality of slats (13), a metal container (12), and a mechanism to move the slats (13), disposed at least partly inside the container (12) and comprising two movement drums (11, 14), and a rod (22) on which the two drums (11, 14) are mounted. The rod (22) comprises at least a first tubular element (30) and a second tubular element (31) telescopic with respect to each other. A first part (20) of the container (12) and a relative first drum are mounted on the first tubular element (30), while a second part (21) of the container (12) and a relative second drum (14) are mounted on the second tubular element (31). The first part (20) and the second part (21) are also able to slide one with respect to the other in order to move the two drums (11, 14) closer to or farther from each other, in order to adapt the width of the container (12) to the width of the aperture, keeping them in a position symmetrical with respect to a median axis (X).

### FIELD OF THE INVENTION

The present invention concerns a Venetian-type blind suitable to be disposed to cover an aperture made in a wall. The Venetian-type blind (hereafter called simply blind) according to the present invention comprises a plurality of slats, a lower counter-weight, and an upper metal container, inside which a mechanism to move the slats is housed.

In the blind according to the invention the width of the metal container can be varied to adapt to the actual width of the aperture.

The blind according to the invention has its main components, slats and lower counter-weight, made preferably of wood, although it comes within the field of the invention that these components are made of other material, for example plastic or metal material.

### BACKGROUND OF THE INVENTION

Venetian blinds are known, used to cover an aperture, for example a window, in the wall of a house. Such blinds normally comprise a plurality of movable slats, a metal container or head rail, for example made of steel or aluminum, disposed above the slats which, at the moment of assembly, is attached to an upper edge of the aperture, and a wooden counter-weight or bottom rail, disposed below the slats. Inside the container a movement mechanism for the slats is housed, which normally comprises two adjustment cords, disposed symmetrically with respect to a median axis of the blind, which pass inside corresponding through holes or hollows made on each of the slats.

The adjustment cords allow to contract or extend the slats and the counter-weight and also to direct the slats according to a plurality of angles, in order to regulate the passage of the light.

The blind is purchased by a client according to the width and height of the aperture on which the blind is to be assembled.

To reduce the production costs of such blinds and to satisfy the requirements of clients, in recent times producers have tried to adopt solutions tending to standardize as much as possible the production of at least some of the components. We have therefore passed from an almost completely made-to-measure production, without the possibility of modifying, after production, the size in width and height of the blind, to a production of pre-assembled blinds, where the final measurements are obtained starting from a blind that is already almost complete, produced according to a plurality of standardized measurements. For example, the blinds are supplied with a determinate number of slats and in a finite series of standardized measurements, for example varying one from the other by 6″, if it is desired to obtain a cover for apertures having a width comprised between 20″ and 72″. Obtaining the final measurements is left to a subject in the intermediate distribution chain, for example a department store, or suchlike, or even to the final client.

To obtain the desired height and width of the blind, starting from pre-assembled blinds of a standardized measurement, normally the following two methods are followed.

The adjustment of the height is performed simply by adding or removing one or more slats to those already present, until the desired drop is reached, and subsequently mounting the counter-weight at the end of the last slat. The adjustment of the width is normally performed by cutting at the sides the metal container, the wooden slats and the wooden counter-weight which have all been pre-assembled.

The operation of cutting a pre-assembled blind, however, presents essentially two difficulties.

The first is that deriving from the presence of the metal container which, in the cutting operation, has different requirements from the slats and the counter-weight. In fact, it is necessary to use a specific cutting machine provided with blades suitable to cut steel, or aluminum, of a certain thickness, of which the container is made, and it is also necessary to use qualified personnel. This is not always possible in the sales points as mentioned above, and even more rarely can this operation be performed by the final client.

The second difficulty is the need to have a cut made equally on both sides of the components, in order to keep the adjustment cords in a symmetrical position with respect to the median axis of the blind, even after cutting, and with equal relative distances from the ends of the components, for both aesthetic and functional reasons.

One purpose of the present invention is to achieve a blind in which the slats and the counter-weight are either made to measure, or after production are taken to the desired measurement by means of a cutting operation on the sides, and the metal container is made in such a manner that the seller, or the final client himself, can vary the width thereof simply and effectively, without the container having to be subjected to complex cutting operations. Another purpose of the present invention is to guarantee in any case, for every width-size obtainable for the blind, that the symmetrical condition of the adjustment cords is maintained.

The Applicant has devised, tested and embodied the present invention to overcome the shortcomings of the state of the art and to obtain these and other purposes and advantages.

### SUMMARY OF THE INVENTION

The present invention is set forth and characterized in the main claim, while the dependent claims describe other characteristics of the invention or variants to the main inventive idea.

In accordance with the above purposes, a Venetian-type blind, or simply blind, according to the present invention comprises a plurality of slats, metal containing means, for example of the box-like type, and a mechanism to move the slats at least partly housed in said containing means.

The movement mechanism comprises at least two movement drums and a rod suitable to move said drums.

According to a characteristic of the present invention, the rod comprises at least a first tubular element and a second tubular element, telescopic with respect to each other. On said first tubular element a respective first part of said containing means and a relative first drum are mounted, while on said second tubular element a respective second part of said containing means and a relative second drum are mounted.

Thanks to this configuration, the first and the second part of the containing means are able to slide with respect to each other so as to move the drums closer to or farther from each other, in order to adapt the width of the metal containing means, taken in their entirety, to the precise width of the aperture.

According to another characteristic of the invention, the movement of reciprocal sliding between the first and the second part of the containing means is configured so as to keep, in all positions, the two drums symmetrical with respect to the median axis of the wooden blind.

The blind according to the present invention thus allows the seller, before final assembly, or even the user himself, to take the metal containing means to the desired width, without needing to subject them to complex cutting operations in suitable apparatuses. Consequently, the blind is simple to make and not expensive, since it only requires the width of the components, normally made of wood, such as slats and counter-weight, to be cut.

In a preferential form of embodiment, the rod also comprises a third central tubular element interposed between the first tubular element and the second tubular element, and telescopic with respect thereto. In this case, the containing means advantageously comprise a central part, associated with said third tubular element, which is interposed between the first part and the second part.

In a preferential embodiment, said central part always remains fixed, while the first and the second part of the containing means can be moved in reciprocally different directions with respect to said central part.

According to other variants, the rod comprises a greater number of tubular elements telescopic with respect to each other, for example five, seven or more, in order to cover even very high ranges of width with the same standardized production.

The blind according to the present invention can be supplied with the containing means, the movement mechanism and the slats already pre-assembled. In this case, each slat comprises, instead of the through holes, a hollow displaced towards a first end of the slat in order to attach a corresponding cord of the movement mechanism.

This solution obviates the need to pre-hole the slats, thus allowing to laterally displace the position of at least one drum, and hence of the relative cord, with respect to the ends of the slats.

The blind can also be achieved by buying the slats, the containing means and the movement mechanism separately, and then assembling them together. In this case, the slats purchased can be prepared already with the desired width and each of them can already comprise the through holes, or the hollows, made in a symmetrical position with respect to the median axis.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a perspective view of a blind according to the present invention;

FIG. 2 is a view from above of a detail of FIG. 1;

FIG. 3 is a schematic front view of another detail of FIG. 1;

FIG. 4 is a schematic front view of a variant of the detail in FIG. 3;

FIG. 5 is a view from above of a variant of FIG. 2;

FIG. 6 is a section from VI to VI of FIG. 3;

FIG. 7 is an enlarged detail of a variant of FIG. 6.

### DETAILED DESCRIPTION OF A PREFERENTIAL FORM OF EMBODIMENT

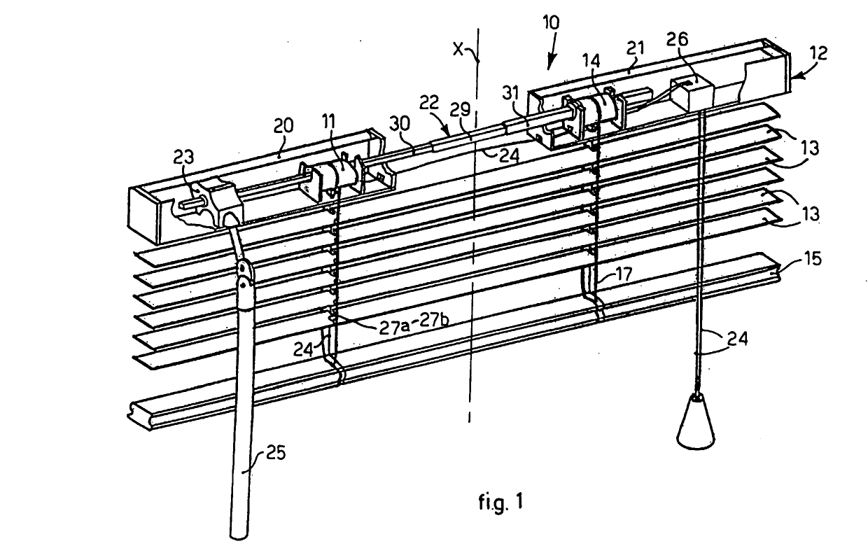

With reference to FIG. 1, a blind 10 according to the present invention is used to cover an aperture, for example a window, of a wall and, in a first preferential form of embodiment, is supplied already assembled to a seller and in a finite series of standardized measurements. The blind 10 must be taken to a final value of width corresponding to that of the specific aperture in which it is applied.

The blind 10 in this case comprises a metal box-like container 12, able to be attached to the upper edge of the aperture to be covered, a plurality of slats 13, for example but not exclusively made of wood, a lower counter-weight 15, also for example made of wood, and a movement mechanism disposed at least partly inside the container 12, which allows to selectively raise/lower the counter-weight 15 and the slats 13, and to direct the angle of the latter in order to regulate the passage of the light.

The container 12 has a substantially U-shaped cross section, so as to allow the movement mechanism to be housed therein, and comprises a left lateral element 20 and a right lateral element 21, disposed in a symmetrical position with respect to a median axis X of the blind 10.

The movement mechanism comprises in this case a first drum 11 and a second drum 14, mounted respectively on the left lateral element 20 and on the right lateral element 21 of the container 12 in a symmetrical position with respect to the median axis X; an adjustment cord 17 having a ladder-like shape and connected both to each slat 13 and to the counter-weight 15, and also to the corresponding drum 11 or 14; a rod 22, on which both the drums 11 and 14 are keyed; and a movement cord 24, which allow to raise or lower the slats 13 and the counter-weight 15 of the blind 10.

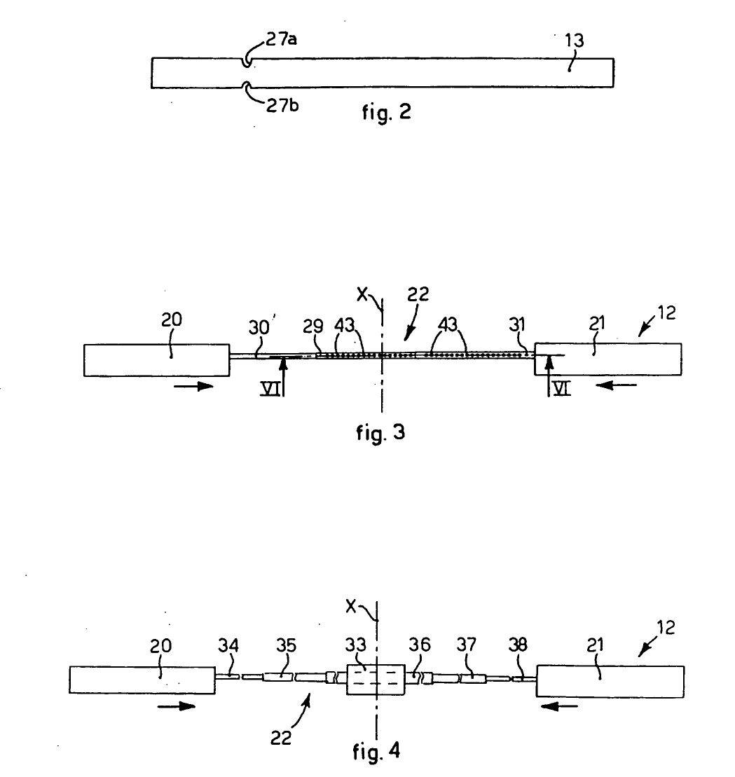

The movement mechanism also comprises a rotation element, or tilter 23, mounted on the left lateral element 20 and able to rotate the rod 22 keyed thereon; a command bar 25, associated with the tilter 23; and a clamping element 26, mounted on the right lateral element 21 and able to clamp the movement cords 24, so as to fix in a determinate position the slats 13 and the counter-weight 15, after they have been moved upwards or downwards. In this case, each slat 13 (FIGS. 1 and 2), in its finished form, has a first hollow 27a, (and a possible second hollow 27b on the other side), made in a position displaced towards one end of the slat 13, and in which a movement cord 24 is made to pass.

By rotating the command bar 25 selectively in a clockwise or anti-clockwise direction, the tilter 23 is activated, which in turn makes the rod 22 rotate in a clockwise or anti-clockwise direction, and consequently the drums 11 and 14 keyed thereon. This rotation determines, in a conventional manner, the winding onto the drums 11 and 14 of part of the adjustment cords 17 and, consequently, the increase or reduction of the inclination of the slats 13, increasing or diminishing the passage of the light through the blind 10.

The rod 22 (FIGS. 1 and 3) comprises in this case a central tubular element 29, a left tubular element 30 and a right tubular element 31, telescopically mobile with respect to each other. To be more exact, the drum 11 is keyed onto the left tubular element 30, while the drum 14 is keyed onto the right tubular element 31; consequently, the left tubular element 30 and the right tubular element 31 are solid respectively with the left lateral element 20 and the right lateral element 21.

A plurality of through holes 43 (FIGS. 3, 5 and 6) are made on the central tubular element 29 and on the right tubular element 31, and are able to cooperate with two positioning elements 39, mounted respectively at one end of both the left tubular element 30 and also the central tubular element 29, so as to clamp in any determinate position the tubular elements 29, 30 and 31 of the rod 22.

Each positioning element 39 comprises a “V” shaped spring 40, and two spheres 41 positioned at each spring's edge and able to engage a mating through hole 42, made on the corresponding tubular element 29, 30, and to be inserted in snap-in manner into the corresponding through hole 43.

To take the pre-assembled blind 10 to the desired value of width, first of all the container 12 is taken to the desired width and afterwards the slats 13 and the counter-weight 15 are shortened, cutting one end thereof on one side only in a machine suitable only for cutting, for example, components made of wood or in any case having an extremely limited thickness. Thanks to the fact that there is the hollow 27 on one side only, the slats 13 can be shortened for the quantity required, until the desired size is obtained, without problems of losing symmetry in the position of the movement cords 24, or of varying the distance between the position of the cords 24 and the ends of the slats 13.

To take the container 12 to the desired measurement, each lateral element 20 and 21 is moved towards the median axis X by a determinate distance, equal to the shortening of the ends of the wooden blind 10. This movement of the lateral elements 20 and 21 is possible due to the fact that the tubular elements 29, 30 and 31 are telescopic and able to slide one with respect to the other. In fact, the left tubular element 30 slides inside the central tubular element 29 which in turn slides inside the right tubular element 31.

By doing this, the drums 11 and 14, and hence the movement cords 24, are kept always in a symmetrical position with respect to the median axis X.

According to a variant (FIG. 4), the container 12 comprises the left lateral element 20, the right lateral element 21 and a central element 33, interposed between the lateral elements 20 and 21. In this variant, the rod 22 comprises five tubular elements 34-38, telescopic with respect to each other: the first tubular element 34 is solid with the left lateral element 21; the third tubular element 36 is solid with the central element 33; the fifth tubular element 38 is solid with the right lateral element 21; the second tubular element 35 is interposed between the first tubular element 34 and the third tubular element 36; and the fourth tubular element 37 is interposed between the third tubular element 36 and the fifth tubular element 38.

To take the container 12 to the correct measurement, the central element 33 and the third tubular element 36, solid therewith, are kept in a fixed position, while both the left lateral element 20 and the right lateral element 21 are moved in the direction of the median axis X, by a distance equal to half the difference between the initial measurement of the container 12 and the final measurement desired.

During the movement of the left tubular element 20, the first tubular element 34 slides inside the second tubular element 35, which slides inside the third tubular element 36. During the movement of the left tubular element 21, the fifth tubular element 38 slides inside the fourth tubular element 37, which slides inside the third tubular element 36.

By doing this, it is possible to shorten the container 12 keeping the different parts of the movement mechanism always in a symmetrical position with respect to the median axis X.

In another form of embodiment, the slats 13 and the counter-weight 15 are supplied separately with respect to the container 12; in this case, the slats 13 and the counter-weight 15 can be already made to measure, or they can be taken to the desired width by means of a separate cutting operation.

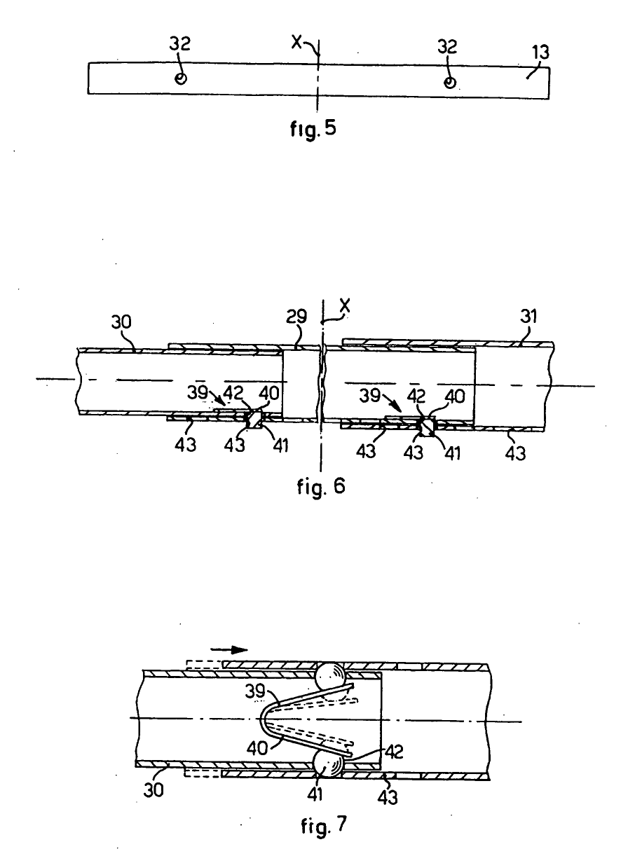

In this specific case, the slats 13 (FIG. 5) can have two through holes 32, disposed in a symmetrical position with respect to the median axis X of the blind 10 and inside each of them one of the movement cords 24 passes.

The slats 13 and the counter-weight 15, if they have to be taken to the correct measurement, are packed together and cut at the ends in the cutting machine, while the container 12 is separately taken to the correct measurement by moving the lateral elements 20 and 21 towards the median axis X. Afterwards, the slats 13, the counter-weight 15 and the container 12 are assembled so as to obtain the desired blind 10.

It is clear that modifications and/or additions of parts may be made to the blind 10 as described heretofore, without departing from the field of the present invention as defined by the claims.

For example, the rod 22 can comprise only two tubular elements telescopic with respect to each other, or the left lateral element 20 and the right lateral element 21 can be telescopic with respect to each other, so that the container 12 completely covers the movement mechanism.

In another variant, the left lateral element 20 and the right lateral element 21 can be telescopic with respect to the central element 29.

1. Venetian-type blind, disposed to cover an aperture of a wall and comprising a plurality of slats (13), metal containing means (12), a mechanism to move said slats (13), disposed at least partly inside said containing means (12) and comprising at least two movement drums (11, 14), and a rod (22) on which said drums (11, 14) are mounted, characterized in that said rod (22) comprises at least a first tubular element (30) and a second tubular element (31) telescopic with respect to each other, a first part (20) of said containing means (12) and a relative first drum being mounted on said first tubular element (30), a second part (21) of said containing means (12) and a relative second drum (14) being mounted on said second tubular element (31), said first part (20) and said second part (21) being able to slide one with respect to the other in order to move said drums (11, 14) closer to or farther from each other, in order to adapt the width of said containing means (12) to the width of said aperture, keeping them in a position symmetrical with respect to a median axis (X).

2. Venetian-type blind as in claim 1, characterized in that said rod (22) also comprises a central tubular element (29), interposed between said first tubular element (30) and said second tubular element (31), and telescopic with respect thereto.

3. Venetian-type blind as in claim 2, characterized in that said containing means (12) comprise a central part (33) interposed between said first part (20) and said second part (21).

4. Venetian-type blind as in claim 3, characterized in that said central tubular element (29) of said rod (22) is solid with said central part (33).

5. Venetian-type blind as in claim 3, characterized in that said rod (22) comprises five or more tubular elements (34,35,36,37,38) telescopic with respect to each other: a first tubular element (34) solid with said first part (20), a fifth tubular element (38) solid with said second part (21), a third tubular element (36) solid with said central part (33), one or more second tubular elements (35), interposed between said first tubular element (34) and said third tubular element (36), and one or more fourth tubular elements (37) interposed between said third tubular element (36) and said fifth tubular element (38).

6. Venetian-type blind as in claim 1, wherein said containing means (12), said movement mechanism and said slats (13) are assembled with each other, and wherein said movement means comprise at least two movement cords (24), characterized in that each of said slats (13) comprises at least a hollow (27a, 27b) displaced towards one end of the relative slat (13) and through which a corresponding movement cord (24) is able to pass.

7. Venetian-type blind as in claim 1, wherein said container (12), said movement mechanism, said slats (13) and said counter-weight (15) are supplied separately, and wherein said movement means comprise at least two movement cords (24), characterized in that each slat (13) comprises two through holes (32) made symmetrically with respect to said median axis (X) and through each of which a corresponding one of said movement cords (24) is able to pass.

8. Venetian-type blind as in claim 1, characterized in that said slats (13) and said counter-weight (15) are made of wood, plastic material or metal material.

9. Venetian-type blind as in claim 2, characterized in that said central tubular element (29) and said first and second tubular elements (31, 30) are provided of a plurality of through holes (42, 43) able to cooperate with positioning elements (39), mounted respectively at one end of both said first and second tubular elements (30, 31) and said central tubular element (29), so as to clamp in any determinate reciprocal position said tubular elements (29, 30, 31) of said rod (22).

10. Venetian-type blind as in claim 9, characterized in that each of said positioning element (39) comprises a “V” shaped spring (40), and two spheres (41) positioned at each spring's edge and able to be inserted in snap-in manner into corresponding through hole (42, 43) provided in said tubular elements (29, 30, 31).
